(19) United States
(12) Patent Application Publication
(10) Pub. No.: US 2024/0150236 A1
(43) Pub. Date: May 9, 2024

(54) DEVICE AND METHOD FOR THE THERMAL TREATMENT OF A MINERAL FEEDSTOCK

(71) Applicants: thyssenkrupp Polysius GmbH, Beckum (DE); thyssenkrupp AG, Essen (DE)

(72) Inventors: Eike WILLMS, Dortmund (DE); Patrick BRUNELOT, Marseille (FR); Martin UHDE, Ennigerloh (DE); Olaf ONTRUP, Herzebrock-Clarholz (DE); Constantin KIMMIG, Soest (DE); Jost LEMKE, Ennigerloh (DE)

(73) Assignees: thyssenkrupp Polysius GmbH, Beckum (DE); thyssenkrupp AG, Essen (DE)

(21) Appl. No.: 18/284,045

(22) PCT Filed: Mar. 18, 2022
(86) PCT No.: PCT/EP2022/057196

§ 371 Date: Sep. 25, 2023

(30) Foreign Application Priority Data
Mar. 26, 2021 (BE) BE 2021/5236
Mar. 26, 2021 (DE) 10 2021 203 071.8

(51) Int. Cl. C04B 7/44; F27B 15/00; F27B 15/08

(52) U.S. Cl. CPC C04B 7/4469; C04B 7/4476; F27B 15/006; F27B 15/08; F27M 2003/03

(57) ABSTRACT

The present invention relates to apparatus for thermal treatment of a mineral starting material, wherein the apparatus comprises a calciner, wherein the calciner comprises at least a first calciner section and a second calciner section, wherein the first calciner section is arranged vertically, wherein the second calciner section is arranged at an incline, wherein the second calciner section has an angle α between the horizontal and the flow direction of the second calciner section, wherein the angle α is between 20° and 80°, wherein the first calciner section has a first hydraulic diameter d_{h,1}, wherein the second calciner section has a second hydraulic diameter d_{h,2}, wherein the second hydraulic diameter d_{h,2} is less than or equal to the first hydraulic diameter d_{h,1} multiplied by the sine of the angle α.

The invention relates to an apparatus and a process for the thermal treatment of mineral starting materials, in particular for producing cement clinker.

A plant for clinker production comprises for example a rotary kiln, a calciner and a preheater. While the material stream of the solid, initially calcareous raw meal mixture and finally cement clinker, passes from the preheater via the calciner into the rotary kiln and then usually into a cooler, the gas flows countercurrently from the rotary kiln to the calciner and from there into the preheater. While in the rotary kiln the material stream of the clinker and the gas stream are run in countercurrent, in the calciner and in the preheater the gas stream and the material stream are in each case in stretches run in cocurrent and subsequently separated in a cyclone. If the solid material is run in cocurrent, the gas stream must also be capable of carrying the material without the material falling out, sedimenting or otherwise precipitating.

In the calciner, combustion of fuel on one hand produces energy in the form of heat while this heat is on the other hand consumed by the endothermic deacidification reaction of the starting material i.e. with emission of CO₂. It is therefore useful to introduce the fuel and the starting material into the calciner in proximity to one another, thus also avoiding areas with elevated temperatures.

Fuels employed are typically atomizable fuels, for example coal dust. However, it is becoming increasingly important to use substitute fuels or to increase the proportion thereof, for example to optimize the CO₂ balance of the overall process and also to allow use of lower-cost fuels. This also allows improved integration of the cement industry into the circular economy. However, due to their size distribution said substitute fuels are not always atomizable, for example the energy required for comminution to achieve atomizability exceeds economically viable levels. In order to also allow use of non-atomizable substitute fuels, it is current practice to place appropriate combustion chambers at the side of the calciner. If the combustion chamber is for example arranged at the side of the calciner without starting material also being supplied there, the location of energy production by combustion and the location of energy consumption by deacidification are spatially separate.

DE 10 2018 206 673 A1 discloses a process for producing cement clinker having an elevated oxygen content.

DE 10 2018 206 674 A1 discloses a further process for producing cement clinker having an elevated oxygen content.

DE 37 35 825 A1 discloses an apparatus for calcination of pulverulent materials.

It is an object of the invention to provide an apparatus and a process which makes it possible to effect combustion of very coarse fuel directly in the calciner.

This object is achieved by the apparatus having the features specified in claim 1 and by the process having the features specified in claim 12. Advantageous developments are apparent from the dependent claims, the following description and the drawings.

The apparatus according to the invention is used for thermal treatment of a mineral starting material. It is preferably an apparatus for producing cement clinker. However, the apparatus may also be utilized for the thermal treatment of clays or for example lithium ores. The production of cement clinker is hereinbelow used as an example. The apparatus comprises a calciner. The apparatus typically further comprises a rotary kiln. Said kiln is arranged downstream of the calciner with respect to the material stream (starting material to product) and upstream of the calciner with respect to the gas stream. However, the rotary kiln may also be omitted for other thermal treatments and a cooler directly connected to the calciner for example. The apparatus typically further comprises a preheater. The preheater is arranged upstream of the calciner with respect to the material stream (starting material to product) and downstream of the calciner with respect to the gas stream. The preheater consists for example of a number of serially arranged cocurrent heat exchangers with downstream separation cyclones. The calciner comprises at least a first calciner section and a second calciner section. The first calciner section is arranged vertically and the second calciner section is arranged at an incline. At an incline is to be understood as meaning that the gas stream through the second calciner section flows neither parallel to the earth's surface nor at an angle of 90° to the earth's surface. The second calciner section has an angle α between the horizontal and the flow direction of the second calciner section. The horizontal is parallel to the earth's surface. The angle α is between 20° and 80°. The first calciner section has a first hydraulic diameter d_{h,1} and the second calciner section has a second hydraulic diameter d_{h,2}. The second hydraulic diameter d_{h,2} is less than or equal to the first hydraulic diameter d_{h,1} multiplied by the sine of the angle α.

d_{h,2}≤d_{h,1}·sin(α)

The hydrodynamic diameter dₕ is four times the quotient of the flow cross section A transverse to the flow direction divided by the flow circumference P.

$${d}_{h} = 4 \cdot \frac{A}{P}$$

In a tubular body having gas flowing through its entirety, for example a tubular first calciner section of radius r, the flow cross section A_{tube} is equal to the circular cross section A_{tube}=π·r² and the flow circumference P_{tube} is equal to the the circumference of a circle P_{tube}=2·π·r. Accordingly the hydrodynamic diameter of a tube is d_{h,tube}=2·r and thus the diameter of the tube. For other geometries a characteristic length is obtained analogously.

In the case of the second hydraulic diameter d_{h,2} it must be noted that upon intended use of a solid fuel this forms a solid bed within the second calciner section which in turn has the result that in regular operation it is not the entire cross sectional area of the second calciner section that is available to the gas stream but rather only the cross section reduced in size by the bed of the solid fuel. In the context of the invention a solid bed is to be understood as meaning all types of layers of solid material comprising heaps or dumped layers. Likewise, the flow circumference P is not the circumference of the second calciner section but rather the circumference P through which the gas stream flows via the bed of the fuel and the upper portion of the second calciner section. However, if a liquid fuel is used, for example high-viscosity oil residues, the film thickness thereof may in some cases be negligible, thus making it possible in this case to use the geometry of the second calciner section as an adequate approximation.

The advantage of the apparatus according to the invention is that by adjusting the cross-section according to the angle α of the second calciner section, the flow velocity along the flow direction is increased such that the velocity component in the z-direction, i.e. perpendicular to the earth's surface, is at least equal to the flow velocity in the vertical first calciner section. Since the velocity component in the z-direction in the second calciner section is thus at least as high as the velocity component in the z-direction in the first calciner section, the load-bearing capacity of the gas flow for the starting material in both calciner sections is at least the same and a separation of the starting material from the gas flow in the second calciner section arranged at an incline can be avoided. This means that no mineral starting material is lost there on account of being deposited on or in a solid fuel. Due to the narrowing and thus altogether higher flow velocity in the second calciner section the effect of reducing the velocity component in the z-direction in the second calciner section is thus at least compensated by the inclined arrangement and accordingly the load-bearing capacity is at least kept constant via the relationship between diameter dₕ, and the angle α according to the invention.

In a further embodiment of the invention, the first calciner section and the second calciner section are configured to have a gas stream flow through them from bottom to top.

In a further embodiment of the invention the first calciner section is arranged below the second calciner section. It is preferable when the first calciner section is arranged directly adjacent to the second calciner section.

In a further embodiment of the invention the apparatus comprises a third calciner section. The third calciner section is arranged vertically. The third calciner section is arranged above the second calciner section. It is preferable when the second calciner section is arranged directly adjacent to the third calciner section.

In a further embodiment of the invention the second calciner section has a first second starting material feed. The first second starting material feed is arranged in the lower 20% of the second calciner section, i.e. at the inlet for the gas flow. The first second starting material feed supplies the starting material into the gas stream of the second calciner section from above or into the gas stream of the second calciner section from the side. The starting material for the calciner is in particular the material for thermal treatment that has been preheated in a preheater, for example and preferably a meal for clinker production. This shall also comprise that the first second starting material feed is arranged in the first calciner section immediately upstream of the second calciner section.

The first calciner section typically also has at least a first first starting material feed. The starting material is thus typically and preferably supplied to the calciner in sub-portions to achieve a spatial distribution of the decarbonation over the entire calciner and thus also to achieve a distribution of the energy consumption over the calciner. In the case of atomizable fuels this is done spatially adjacently. Thus, a first sub-amount of starting material is supplied via the first first starting material feed and a second sub-amount is supplied via the first second starting material feed.

Correspondingly a third calciner section may preferably have at least a first third starting material feed arranged in it.

In a further embodiment of the invention the second calciner section additionally has a second second starting material feed. The second second starting material feed is arranged in the middle region of the second calciner section, wherein the second second starting material feed supplies the starting material into the gas stream of the second calciner section from above or into the gas stream of the second calciner section from the side. As a result the starting material is supplied with greater spatial distribution which also has the result that the energy consumption by the decarbonation occurs with greater spatial distribution, thus leading to uniformization of the temperature and thus of the reaction conditions. It goes without saying that the second calciner section may also have further second starting material feeds to achieve further uniformization. It is preferable when the supplying of the starting material via the first second starting material feed is carried out in a constant manner and the second second starting material feed is used variably in order in particular to dynamically adapt the supplied amount of starting material to the typically varying liberated amount of energy from a substitute fuel. Thus in the case of a substitute fuel with a relatively low calorific value less starting material would be supplied via the second second starting material feed and in the case of a substitute fuel with a relatively high calorific value more starting material would be supplied via the second second starting material feed.

In a further embodiment of the invention the second calciner section additionally has a third second starting material feed. The third second starting material feed is arranged in the upper 20% of the second calciner section, wherein the third second starting material feed supplies starting material into the gas stream of the second calciner section from above or into the gas stream of the second calciner section from the side. As a result the starting material is supplied with greater spatial distribution which also has the result that the energy consumption by the decarbonation occurs with greater spatial distribution, thus leading to uniformization of the temperature and thus of the reaction conditions. It goes without saying that the second calciner section may also have further second starting material feeds to achieve further uniformization.

In a further embodiment of the invention a second fuel feed for a solid fuel is arranged at the upper end of the second calciner section. By way of example and preferably a substitute fuel may be supplied via the second fuel feed. Examples of substitute fuels include household, industrial or commercial waste, waste tires, sewage sludge and biomass. The calorific value of substitute fuels can vary greatly. Substitute fuels can therefore also be introduced as a mixture of different fractions to achieve a certain calorific value. Since the fractions having a lower calorific value and coarser size distribution are normally cheaper, this also achieves a cost optimization. The inclined arrangement of the second calciner section thus also makes it possible to burn non-atomizable substitute fuel directly in a calciner in immediate proximity to the chemical reaction of the starting material to afford the product and thus to provide the energy close to the reaction thereof. In order to allow better combustion of certain substitute fuels the lower side of the second calciner section may be stepped or the lower side of the second calciner section may have a forwards or backwards moving grate, wherein a forwards or backwards moving grate may also be stepped. In the context of the invention the lower side is the floor, i.e. the region along which a solid would slide due to gravity. Analogously, the upper side and the lateral sides would then be the part that confines the gas stream in the upwards or lateral direction.

In a further embodiment of the invention the second calciner section has an angle α between the horizontal and the flow direction of the second calciner section, wherein the angle α is between 30° and 70°, preferably between 35° and 60°, more preferably between 40° and 55°, particularly preferably between 40° and 50°. An optimum is to be selected here. The steeper the second calciner section, the greater the velocity component of the gas stream in the z-direction and the more easily the particles remain in the gas stream. On the other hand a flat construction is advantageous especially for substitute fuels having a coarse size distribution and/or a high moisture content.

In a further embodiment of the invention the second calciner section is arranged below the first calciner section and a controllable bypass is arranged parallel to the second calciner section. The lower end of the second calciner section may for example also be aligned with the first calciner section. In this case the upper end of the second calciner section and the lower end of the first calciner section are for example connected to one another by a horizontal connecting piece, wherein the controllable bypass is then arranged directly vertically below the first calciner section.

In a further aspect the invention relates to a process for operating an apparatus for thermal treatment of a mineral starting material. It is preferably a process for operating an apparatus for producing cement clinker. However, the apparatus may also be utilized for the thermal treatment of clays or for example lithium ores. The production of cement clinker is hereinbelow used as an example. The process is performed in an apparatus comprising a calciner having a vertical first calciner section and an inclined second calciner section. The process is preferably performed in an apparatus according to the invention. During operation a gas stream is passed through the first calciner section and the second calciner section. By way of example and preferably the gas stream originates from a rotary kiln. By way of example and preferably the gas stream contains mainly oxygen and, in addition, the CO₂ produced in the rotary kiln by combustion and residual deacidification of the starting material (typically around 10% of the total deacidification). The gas stream preferably contains less than 20% by volume of nitrogen, particularly preferably less than 15% by volume of nitrogen, preferably about 50% to 70% by volume of oxygen. The abovementioned values relate to dry gas, i.e. without taking water into account. It is preferable when the inflowing gas stream comprises sufficient oxygen for combustion of the fuels supplied to the calciner. According to the invention the apparatus is operated such that at any point in the second calciner section the Froude number Fr is equal to or greater than the minimum Froude number Fr in the first calciner section. The Froude number Fr is the velocity component of the gas stream in the vertical direction v_{z} divided by the square root of the product of acceleration due to gravity g and the hydraulic diameter dₕ.

$$F r = \frac{{v}_{z}}{\sqrt{g \cdot {d}_{h}}}$$

where:

$${d}_{h} = 4 \cdot \frac{A}{P}$$

The hydraulic diameter is four times the quotient of the flow cross section A perpendicular to the flow direction divided by the flow circumference P.

While in the vertical first calciner section the velocity component of the gas stream in the vertical direction v_{z} is equal to the flow velocity of the gas stream v, in the inclined second calciner section the angle α must be taken into account. Here, the velocity component of the gas stream in the vertical direction v_{z} is the flow velocity of the gas stream v multiplied by the sine of the angle α.

v_{z}=v·sin(α)

However, it is necessary to take into account that the flow velocity is not a constant. The flow velocity within the calciner is altered by various processes. Temperature differences lead to differences for instance. In regions with higher temperatures, the gas wants to occupy more space, thus increasing the velocity v. Likewise the deacidification of the starting material results in emission of CO₂ which increases the amount of substance and thus also leads to an increase in the flow velocity. The fuel can also result in an increase in the amount of substance, for example due to water liberated or formed during combustion. These effects mean that the Froude number is not constant at constant geometry within a calciner section but rather differs according to location.

Since the Froude number is to be considered as a measure of the load-bearing capacity of the gas stream for the starting material which is in the form of a solid and the load-bearing capacity in the second calciner section must be at least as high as in the first calciner section, the Froude number in the second calciner section must be greater everywhere than the minimum Froude number in the first calciner section. However, it must be taken into account that the angle of inclination a does not enter the whole flow velocity v, but only its z-component v_{z}, into the calculation and also only contributes to the load-bearing capacity. The focus is only on the minimum in the first calciner section since the load capacity must be sufficient here too. An increase in the Froude number, for example through liberation of CO₂ during deacidification, will result in higher values locally if a constant geometry within the first calciner section is assumed.

The calciner is particularly preferably operated with turbulent flow. As a result, the velocity profile of the flow exhibits only small variations over the width of the flow. In the case of laminar flow the velocity of the gas stream has a distribution over the width which is zero at the edge and has a maximum in the middle. This would make the load bearing capacity location-dependent, thus complicating process management.

In another embodiment of the invention the calciner is operated with an atmosphere comprising less than 25% nitrogen, preferably comprising less than 15% nitrogen, more preferably comprising less than 10% nitrogen, particularly preferably comprising less than 5% nitrogen.

In a further embodiment of the invention the Froude number in the second calciner section is selected to be greater than 0.7, preferably greater than 2. Furthermore, the Froude number in the second calciner section is selected to be smaller than 9, preferably smaller than 4.

In a further embodiment of the invention in the second calciner section starting material is supplied at at least two positions via a first second starting material feed and a second second starting material feed. This is effected spaced apart from one another along the flow direction. This achieves a uniformization of the reaction and thus of the energy consumption and thus of the temperature.

In a further embodiment of the invention, a solid fuel is supplied and burnt in the second calciner section. By way of example and preferably a substitute fuel may be supplied via the second fuel feed. Examples of substitute fuels include household, industrial or commercial waste, waste tires, sewage sludge and biomass. The calorific value of substitute fuels can vary greatly. Substitute fuels can therefore also be introduced as a mixture of different fractions to achieve a certain calorific value. Since the fractions having a lower calorific value are normally cheaper, this also achieves a cost optimization. The inclined arrangement of the second calciner section thus also makes it possible to burn non-atomizable substitute fuel directly in a calciner in immediate proximity to the chemical reaction of the starting material to afford the product and thus to provide the energy close to the reaction thereof. In order to allow better burning of certain substitute fuels the lower side of the second calciner section may be stepped or the lower side of the second calciner section may be conveyed using a forwards or backwards moving grate, wherein a forwards or backwards moving grate may also be stepped.

In a further embodiment of the invention a solid fuel with a chunk size of at least 90% of the mass of the fuel of more than 50 mm, preferably more than 70 mm, particularly preferably of 100 mm, is supplied in the second calciner section.

In a further embodiment of the invention an atomizable fuel is supplied in the first calciner section. In addition, starting material is supplied via a first starting material feed in the first calciner section. Fuel and starting material are preferably supplied spatially adjacently to one another to provide a spatial connection between energy production and energy consumption.

The apparatus according to the invention is more particularly elucidated hereinbelow with reference to a working example shown in the drawings.

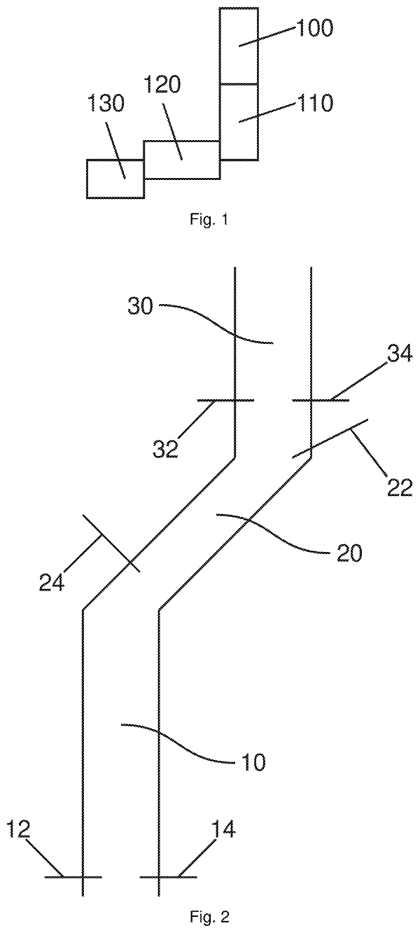

FIG. 1 Apparatus for thermal treatment of a mineral starting material

FIG. 2 First exemplary calciner

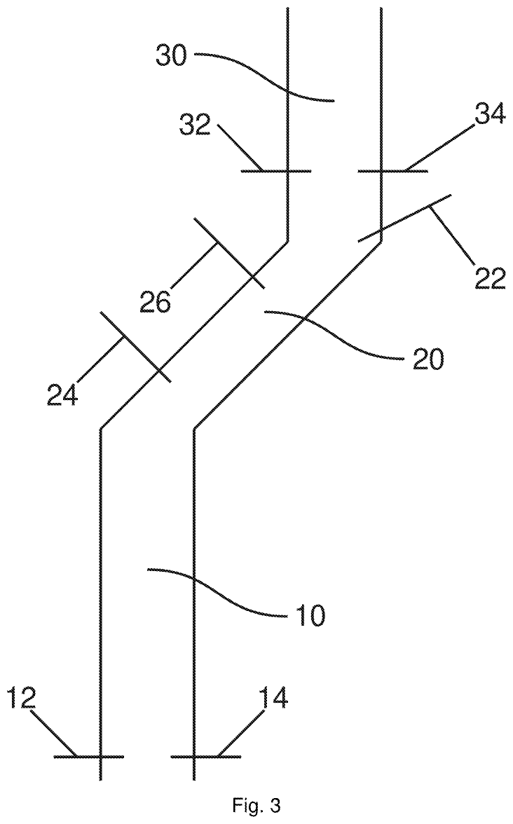

FIG. 3 Second exemplary calciner

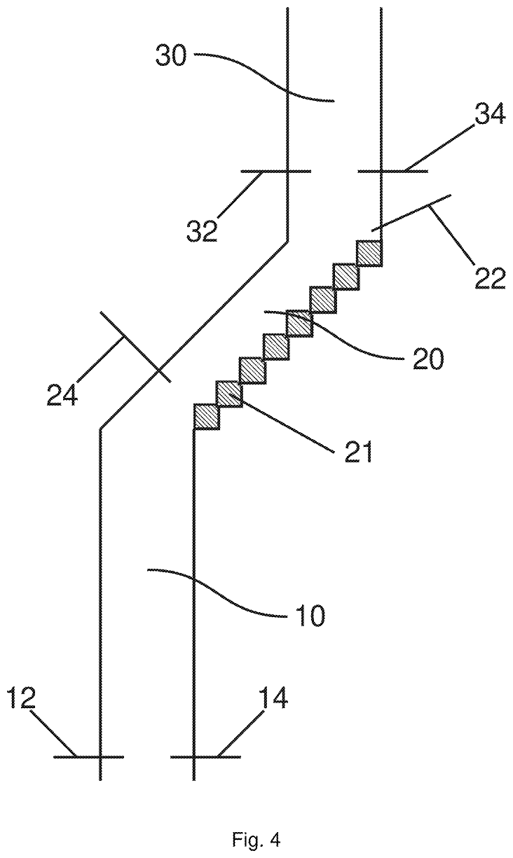

FIG. 4 Third exemplary calciner

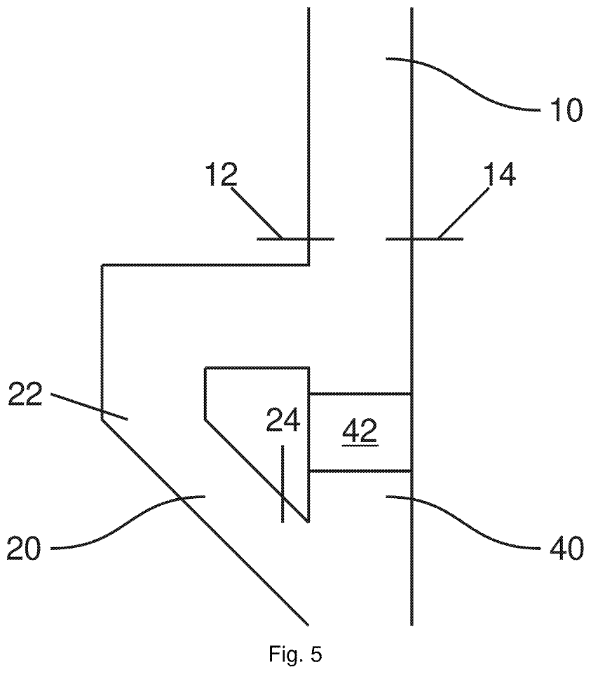

FIG. 5 Fourth exemplary calciner

All illustrations are purely schematic, not to scale and are only used to elucidate the features of the invention.

FIG. 1 shows an apparatus for thermal treatment of a mineral starting material, for example a plant for production of cement clinker. The plant comprises a preheater 100, a calciner 110, a rotary kiln 120 and a cooler 130. The material, for example raw meal made from limestone is applied at the top, passes through the plant in the recited sequence and may be withdrawn from the cooler 130 as clinker. The gas flow is passed from the rotary kiln 120 into the calciner 110 and from there into the preheater 100 in countercurrent to the material stream.

Therefore in the following four exemplary calciner embodiments shown the gas stream enters from below from the direction of the rotary kiln 120 and flows upwards. The calciner 110 in each case has at least one cyclone separator not shown in the exemplary embodiments at the upper end.

In the following, identical reference numerals are used for identical elements and the differences between embodiments are elaborated in the description.

FIG. 2 shows a first calciner section 10 arranged vertically, thereabove a second calciner section 20 inclined at an angle of 45° and thereabove a third calciner section 30 arranged vertically. The first calciner section 10 has a first fuel feed 12 for an atomizable fuel, for example coal dust, and a first first starting material feed 14, by means of which starting material from the preheater 100 is supplied. The combustion of the fuel in the first calciner section 10 forms energy which is used for the deacidification of the starting material, thus generating CO₂. In the second calciner section 20 a solid fuel is supplied from above through the second fuel feed 22, for example via a screw, and said fuel is then burnt on the inclined surface of the second calciner section 20. Combustion residues, for example metal constituents of the fuel, fall through the first calciner section 10 and may then be withdrawn therebelow. The second calciner section 20 further comprises a first second starting material feed 24, by means of which starting material from the preheater may likewise be added. Arranged above the second calciner section 20 is a third calciner section 30 which comprises a third fuel feed 32 and a first third starting material feed 34.

As indicated in FIG. 2 the cross section of the second calciner section 20 is smaller than the cross section of the first calciner section 10. For example the cross section is about 30% smaller than the cross section of the first calciner section 10, which corresponds to the sine of 45°.

In the second embodiment of the calciner 110 shown in FIG. 3 the second calciner section 20 comprises, additionally to the first embodiment shown in FIG. 2, a second second starting material feed 26 which makes it possible to achieve better uniformization of the energy consumption and thus of the temperature in the second calciner section 20.

In the third embodiment of the calciner 110 shown in FIG. 4, the second calciner section 20 has steps 21 for the combustion of a solid fuel. The steps 21 may be level as in the example shown but the steps 21 may also be inclined in the flow direction or counter to the flow direction.

The fourth embodiment of the calciner 110 shown in FIG. 5 has a markedly different construction. The gas stream is initially split and only a substream is passed through the second calciner section 20. A further substream flows past the second calciner section via a bypass and a flow control valve 42 and is recombined with the gas stream exiting the second calciner section 20 and then passed into the first calciner section 10.

### LIST OF REFERENCE NUMERALS

10 First calciner section
12 First fuel feed
14 First first starting material feed
20 Second calciner section
21 Steps
22 Second fuel feed
24 First second starting material feed
26 Second second starting material feed
30 Third calciner section
32 Third fuel feed
34 First third starting material feed
40 Bypass
42 Flow control valve
100 Preheater
110 Calciner
120 Rotary kiln
130 Cooler

1-17. (canceled)

18. An apparatus for thermal treatment of a mineral starting material, comprising:
a calciner, including at least a first calciner section and a second calciner section, wherein the first calciner section is arranged vertically, wherein the second calciner section is arranged at an incline, wherein the second calciner section has an angle α between the horizontal and a flow direction of the second calciner section, wherein the angle α is between 20° and 80°, wherein the first calciner section includes a first hydraulic diameter d_{h,1}, wherein the second calciner section includes a second hydraulic diameter d_{h,2}, wherein the second hydraulic diameter d_{h,2} is less than or equal to the first hydraulic diameter d_{h,1} multiplied by the sine of the angle α.

19. The apparatus of claim 18, wherein the first calciner section and the second calciner section are configured to have a gas stream flow through them from bottom to top.

20. The apparatus of claim 18, wherein the first calciner section is arranged below the second calciner section.

21. The apparatus of claim 18, further comprising a third calciner section, wherein the third calciner section is arranged vertically, and above the second calciner section.

22. The apparatus of claim 18, wherein the second calciner section includes a first starting material feed, wherein the first starting material feed is arranged in the lower 20% of the second calciner section, wherein the first starting material feed supplies starting material into the gas stream of the second calciner section from above or into the gas stream of the second calciner section from the side.

23. The apparatus of claim 23, wherein the second calciner section includes a second starting material feed, wherein the second starting material feed is arranged in a middle region of the second calciner section, wherein the second starting material feed supplies starting material into the gas stream of the second calciner section from above or into the gas stream of the second calciner section from the side.

24. The apparatus of claim 18, wherein a second fuel feed for a solid fuel is arranged at an upper end of the second calciner section.

25. The apparatus of claim 18, wherein the lower side of the second calciner section is stepped.

26. The apparatus of claim 18, wherein the lower side of the second calciner section includes a moving grate.

27. The apparatus of claim 18, wherein the second calciner section includes an angle α between the horizontal and the flow direction of the second calciner section, wherein the angle α is between 30° and 70°.

28. The apparatus of claim 18, wherein the second calciner section is arranged below the first calciner section and a controllable bypass is arranged parallel to the second calciner section.

29. A process for operating an apparatus for thermal treatment of a mineral starting material, wherein the process is performed in an apparatus comprising a calciner having a vertical first calciner section and an inclined second calciner section, comprising:
passing a gas stream through the first calciner section and the second calciner section, wherein the hydraulic diameter is four times a quotient of the Froude number flow cross section perpendicular to the flow direction divided by the flow circumference, wherein the Froude number at any point in the second calciner section is equal to or greater than a minimum Froude number in the first calciner section.

30. The process of claim 29, wherein the calciner is operated with an atmosphere comprising less than 25% nitrogen, preferably comprising less than 15% nitrogen, more preferably comprising less than 10% nitrogen, particularly preferably comprising less than 5% nitrogen.

31. The process of claim 29, wherein the Froude number in the second calciner section is greater than 0.7 and smaller than 9.

32. The process of claim 29, wherein second calciner section starting material is supplied from at least two positions via a first second starting material feed and a second starting material feed which are spaced apart from one another along the flow direction.

33. The process of claim 29, wherein a solid fuel with a chunk size of at least 90% of the mass of the fuel of more than 50 mm, is supplied in the second calciner section.

34. The process of claim 29, wherein an atomizable fuel is supplied in the first calciner section and starting material is supplied via a first starting material feed in the first calciner section.
